(19) United States
(12) Patent Application Publication
(10) Pub. No.: US 2022/0215482 A1
(43) Pub. Date: Jul. 7, 2022

(54) USER INFORMATION PROCESSING METHOD, APPARATUS, ELECTRONIC DEVICE, AND COMPUTER STORAGE MEDIUM

(71) Applicant: BEIJING BYTEDANCE NETWORK TECHNOLOGY CO., LTD., Beijing (CN)

(72) Inventor: Xiao WANG, Beijing (CN)

(21) Appl. No.: 17/609,380

(22) PCT Filed: Jan. 16, 2020
(86) PCT No.: PCT/CN2020/072494

§ 371 Date: Nov. 6, 2021

(30) Foreign Application Priority Data
May 7, 2019 (CN) 201910376994.X

(51) Int. Cl. G06Q 50/00; G06F 9/451; G06F 3/04847; G06F 3/0482

(52) U.S. Cl. CPC G06Q 50/01; G06F 9/451; H04L 67/12; G06F 3/0482; G06F 3/04847

(57) ABSTRACT

The embodiments of the present disclosure provide a method and apparatus for processing user information, electronic device, and computer storage medium. The method comprises: receiving a follower number viewing operation for a current user, through a current user interface of a current platform; and in response to the follower number viewing operation, acquiring and displaying a number of users following the current user on relevant platforms, wherein the relevant platforms include the current platform and an associated platform associated with the current platform among the current user's registered platforms. Through the embodiments of the present disclosure, the number of users following the current user on the current platform and other associated platforms may be obtained on the current platform, such that the number of users following the current user on different platforms may be known on one platform at the same time, which improves the user's interaction experience.

### CROSS-REFERENCE TO RELATED APPLICATION

The present disclosure claims the priority of Chinese Patent Application No. 201910376994.X filed on May 7, 2019, the entire contents of which are incorporated herein by reference for all purposes.

### TECHNICAL FIELD

The present disclosure relates to the field of Internet technology. Specifically, the present disclosure relates to a method and apparatus for processing user information, electronic device, and computer storage medium.

### BACKGROUND

With the improvement of people's living standards and the rapid development of technology, terminal application programs have become an indispensable part of people's lives. In order to better satisfy people's experience and enrich people's lives, mobile social platforms have developed rapidly. Through the mobile social platform, a user can share information anytime and anywhere, and can also learn about dynamic information of the people he/she follows through the social platform.

As needed, the user may register on multiple social platforms at the same time. On different social platforms, the user may publish the same information or upload different information. On social platforms, the user's popularity may be reflected by the number of fans. However, in the existing technics, on one platform, only the number of fans of the user on the current platform can be obtained. If one wants to know the number of fans of the user on other platforms, he/she need to find the user on the corresponding platform to obtain the corresponding number of fans, resulting in complexity of user operations and poor user interaction experience.

### SUMMARY

The purpose of the present disclosure is to solve at least one of the above technical defects and improve the user experience. The technical solutions used in the present disclosure are as follows:

In a first aspect, the present disclosure provides a method for processing user information, comprising:

receiving a follower number viewing operation for a current user, through a current user interface of a current platform; and

in response to the follower number viewing operation, acquiring and displaying the number of users following the current user on relevant platforms, wherein the relevant platforms include the current platform and an associated platform associated with the current platform among the current user's registered platforms.

In an optional embodiment in the first aspect, the associated platform is determined through following ways:

displaying an option of the platform to be associated, when receiving a setting operation for a platform to be associated; and

receiving an associated platform selection operation for the option of the platform to be associated, associating the current platform with the platform to be associated through a server, and determining the platform to be associated as the associated platform of the current platform.

In an optional embodiment in the first aspect, the associating the current platform with the platform to be associated through the server comprises:

associating a first user identification of the current user on the current platform, a first platform identification of the current platform, a second platform identification of the platform to be associated, with a second user identification of the current user on the platform to be associated, through the server;

wherein, the server is a first server corresponding to the current platform and a second server corresponding to the platform to be associated, and at least one of the first server and the second server is a different server, or, the first server and the second server are the same server.

In an optional embodiment in the first aspect, in response to the follower number viewing operation, acquiring the number of users following the current user on the relevant platforms, comprises:

acquiring the number of users following the current user, based on the first user identification and the first platform identification in the follower number viewing operation.

In an optional embodiment in the first aspect, the acquiring the number of users following the current user, based on the first user identification and the first platform identification in the follower number viewing operation, comprises:

sending to the server a request for acquiring the number of followers, when receiving the follower number viewing operation, the request for acquiring the number of followers comprising the first user identification and the first platform identification;

receiving the number of users following the current user, returned by the server based on the request for acquiring the number of followers, wherein the server acquires the number of users following the current user by the following ways:

acquiring the number of users following the current user on the current platform, based on the first user identification and the first platform identification;

determining the second platform identification associated with the first platform identification, based on the first user identification and the first platform identification;

determining the second user identification of the current user on the associated platform corresponding to the second platform identification, based on the second platform identification and the first user identification; and

acquiring the number of users following the current user on the associated platform corresponding to the second platform identification, based on the second user identification and the second platform identification.

In an optional embodiment in the first aspect, after acquiring and displaying the number of users following the current user on the relevant platforms, the method further comprises:

receiving a platform selection operation with respect to a target platform of the relevant platforms; and

in response to the platform selection operation, displaying an information display interface corresponding to the target platform.

In an optional embodiment in the first aspect, if an application program corresponding to the target platform is not installed on a terminal device corresponding to the current platform, the information display interface includes an application download guide interface corresponding to the target platform.

In an optional embodiment in the first aspect, the number of users following the current user is displayed by at least one of the following ways:

displaying platform identification of each platform of the relevant platforms and the number of users corresponding to the platform separately; and

displaying a sum of the number of users corresponding to each platform of the relevant platforms.

In a second aspect, the present disclosure provides an apparatus for processing user information, comprising:

a viewing operation reception module, configured to receive an follower number viewing operation for a current user, through a current user interface of a current platform; and

a user number displaying module, configured to acquire and display the number of users following the current user on relevant platforms, in response to the follower number viewing operation, wherein the relevant platforms include the current platform and an associated platform associated with the current platform among the current user's registered platforms.

In an optional embodiment in the second aspect, the apparatus further comprise an associated platform determination module, which determines the associated platform through following ways:

displaying an option of the platform to be associated, when receiving a setting operation for a platform to be associated; and

receiving an associated platform selection operation for the option of the platform to be associated, associating the current platform with the platform to be associated through a server, and determining the platform to be associated as the associated platform of the current platform.

In an optional embodiment in the second aspect, when the associating the current platform with the platform to be associated through the server, the associated platform determination module is specifically configured to:

associate a first user identification of the current user on the current platform, a first platform identification of the current platform, a second platform identification of the platform to be associated, with a second user identification of the current user on the platform to be associated, through the server;

wherein, the server is a first server corresponding to the current platform and a second server corresponding to the platform to be associated, and at least one of the first server and the second server is a different server, or, the first server and the second server are the same server.

In an optional embodiment in the second aspect, when acquiring the number of users following the current user on the relevant platforms, in response to the follower number viewing operation, the user number displaying module is specifically configured to:

acquire the number of users following the current user, based on the first user identification and the first platform identification in the follower number viewing operation.

In an optional embodiment in the second aspect, when acquiring the number of users following the current user, based on the first user identification and the first platform identification in the follower number viewing operation, the user number displaying module is specifically configured to:

send to the server a request for acquiring the number of followers, when receiving the follower number viewing operation, the request for acquiring the number of followers comprising the first user identification and the first platform identification;

receive the number of users following the current user, returned by the server based on the request for acquiring the number of followers, wherein the server acquires the number of users following the current user by the following ways:

acquire the number of users following the current user on the current platform, based on the first user identification and the first platform identification;

determine the second platform identification associated with the first platform identification, based on the first user identification and the first platform identification;

determine the second user identification of the current user on the associated platform corresponding to the second platform identification, based on the second platform identification and the first user identification; and

acquire the number of users following the current user on the associated platform corresponding to the second platform identification, based on the second user identification and the second platform identification.

In an optional embodiment in the second aspect, the apparatus further comprises a platform selection module;

the platform selection module is configured to: receive a platform selection operation with respect to a target platform of the relevant platforms, after acquiring and displaying the number of users following the current user on the relevant platforms; and display an information display interface corresponding to the target platform, in response to the platform selection operation.

In an optional embodiment in the second aspect, if an application program corresponding to the target platform is not installed on a terminal device corresponding to the current platform, the information display interface includes an application download guide interface corresponding to the target platform.

In an optional embodiment in the second aspect, the user number displaying module is specifically configured to display the number of users following the current user by at least one of the following ways:

displaying platform identification of each platform of the relevant platforms and the number of users corresponding to the platform separately; and

displaying a sum of the number of users corresponding to each platform of the relevant platforms.

In a third aspect, the present disclosure provides an electronic device, which comprises a processor and a memory, wherein the memory is configured to store computer operation instruction; and the processor is configured to execute the method in any embodiment in the first aspect of the present disclosure, by invoking the computer operation instruction.

In a fourth aspect, the present disclosure provides a computer-readable storage medium, wherein the computer-readable storage medium stores at least one instruction, at least one program, a code set or an instruction set, which is loaded and executed by a processor to implement the method in any embodiment in the first aspect of the present disclosure.

The beneficial effects brought about by the technical solutions provided by the embodiments of the present disclosure are as follows:

The method and apparatus for processing user information, electronic device, and computer storage medium in the embodiment of the present disclosure, may receive a follower number viewing operation for a current user, through a current user interface of a current platform; and based on the follower number viewing operation, may acquire the number of users following the current user on relevant platforms and display it through a data display interface. Since the relevant platforms include the current platform and an associated platform associated with the current platform among the current user's registered platforms, the number of users following the current user on the current platform and other associated platforms may be obtained on the current platform, such that the number of users following the current user on different platforms may be known on one platform at the same time, which improves the user's interaction experience.

### BRIEF DESCRIPTION OF THE DRAWINGS

In order to illustrate the technical solutions more clearly in the embodiments of the present disclosure, the following will briefly introduce the drawings that need to be used in the description of the embodiments of the present disclosure.

FIG. 1 is a schematic flowchart of a method for processing user information in an embodiment of the present disclosure;

FIG. 2a is a schematic diagram of a current user interface in an embodiment of the present disclosure;

FIG. 2b is a schematic diagram of a data display interface in an embodiment of the present disclosure;

FIG. 2c is a schematic diagram of an application download guide interface in an embodiment of the present disclosure;

FIG. 2d is a schematic diagram of an information display interface in an embodiment of the present disclosure;

FIG. 3 is a schematic structural diagram of an apparatus for processing user information in an embodiment of the present disclosure; and

FIG. 4 is a schematic structural diagram of an electronic device in an embodiment of the present disclosure.

### DETAILED DESCRIPTION

Embodiments of the present invention will be described in detail hereafter. The examples of these embodiments have been illustrated in the drawings throughout which same or similar reference numerals refer to same or similar elements or elements having same or similar functions. The embodiments described hereafter with reference to the drawings are illustrative, merely used for explaining the present invention and should not be regarded as any limitations thereto.

It should be understood by those skill in the art that singular forms “a”, “an”, “the”, and “said” may be intended to include plural forms as well, unless otherwise stated. It should be further understood that terms “include/including” used in this specification specify the presence of the stated features, integers, steps, operations, elements and/or components, but not exclusive of the presence or addition of one or more other features, integers, steps, operations, elements, components, and/or combinations thereof. It should be understood that, when a component is referred to as being “connected to” or “coupled to” another component, it may be directly connected or coupled to other elements or provided with intervening elements therebetween. In addition, “connected to” or “coupled to” as used herein may include wireless connection or coupling. As used herein, term “and/or” includes all or any of one or more associated listed items or combinations thereof.

The technical solutions of the present disclosure and how the technical solutions of the present disclosure solve the above technical problems are described in detail below with specified embodiments. The following specified embodiments can be combined with each other, and the same or similar concepts or processes may not be repeated in some embodiments. The embodiments of the present disclosure will be described below in conjunction with the accompanying drawings.

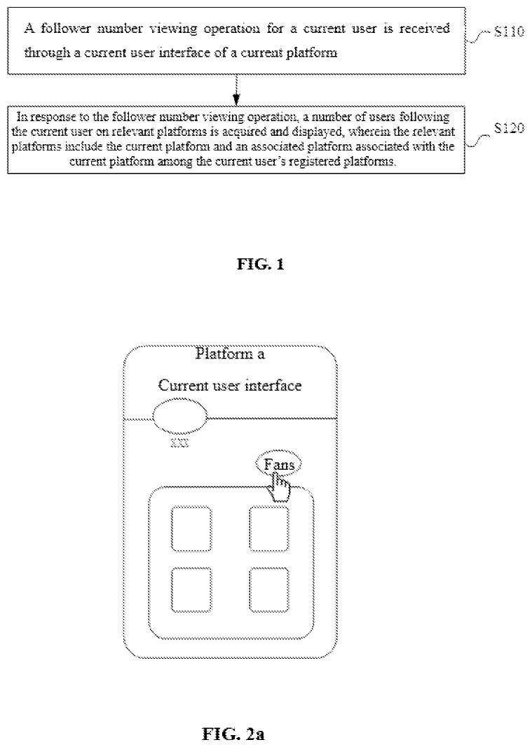

FIG. 1 illustrates a schematic flowchart of a method for processing user information. An embodiment of the present disclosure provides a method for processing user information, as shown in FIG. 1, and the method may include steps as follows:

Step S110, a follower number viewing operation for a current user is received through a current user interface of a current platform.

The current user refers to an author corresponding to contents displayed on the current user interface, and the user who triggers a follower number viewing operation may be the current user himself or another user who is different from the current user.

The current user interface is a user interface displayed in the user client. The user interface is used for the interaction between the terminal device and the user. The user's related operations may be received through the interface, such as, an operation for viewing the current display information on the current user interface. Where, the current display information indicates the information currently displayed on the user interaction interface, which may include different types of information, such as, information related to text, pictures, symbols, advertisements and video. The present disclosure does not limit expression forms of currently displayed information.

The follower number viewing operation refers to the operation of the user to view the number of users following the current user based on the current user interface. The specific form of the operation may be configured as needed. For example, it may be a trigger operation of the user at a specific operation position on the interface of application program in the client. In practical applications, the operation may be triggered by a relevant trigger identification in the client, such as a specific trigger button or input box on the interface in the client, or triggered by a user's voice command The present disclosure does not limit the specific implementation form for triggering the follower number viewing operation.

Step S120, in response to the follower number viewing operation, the number of users following the current user on relevant platforms is acquired and displayed, wherein the relevant platforms include the current platform and an associated platform associated with the current platform among the current user's registered platforms.

The number of users following the current user indicates the number of fans of the current user. In actual applications, a user may have registered on multiple platforms, and there may be fans of the user on different platforms. If the current platform is associated with a platform of the current user's registered platforms, the number of fans of the current user on different platforms can be obtained on the current platform at the same time.

The current user interface can display relevant information of the current user or other users. If the current user interface displays relevant information of the current user, the current user can view the number of followers herself/himself on each platform through the current user interface. If the current user interface displays relevant information of other users, the current user can view the number of followers of other users on each platform through the current user interface.

It is understandable that since the number of followers of a user on a platform is constantly changing, the number of users obtained based on each follower number viewing operation may be different or the same.

The solutions in the embodiment of the present disclosure, may receive a follower number viewing operation for a current user, through a current user interface of a current platform; and based on the follower number viewing operation, may acquire the number of users following the current user on relevant platforms and display it through a data display interface. Since the relevant platforms include the current platform and an associated platform associated with the current platform among the current user's registered platforms, the number of users following the current user on the current platform and other associated platforms may be obtained on the current platform, such that the number of users following the current user on different platforms may be known on one platform at the same time, which improves the user's interaction experience.

In an embodiment of the present disclosure, the associated platform is determined through following ways:

displaying an option of the platform to be associated, when receiving a setting operation for a platform to be associated; and

receiving an associated platform selection operation for the option of the platform to be associated, associating the current platform with the platform to be associated through a server, and determining the platform to be associated as the associated platform of the current platform after associating.

If the current user wants to view, in the current user interface, the number of users following the current user on an associated platform, she/he needs to associate the current platform with at least one of the other registered platforms. In the platform where the current user has registered, the current user can configure which platform or several platforms of the registered platforms are associated with the current platform based on actual needs, that is, the platform to be associated is one or multiple of the current user's registered platforms.

In actual applications, when the client receives the user's associated platform selection operation, the server can complete the association between the platform to be associated with the current platform, and feed back the associated result to the client.

The setting operation refers to an operation through which the user associates the current platform with other platforms, and the specific form of the operation may be configured as needed. The associated platform selection operation refers to an operation through which the user selects the platform to be associated based on the options of the platform to be associated, and the specific form of the operation may be configured as needed. The setting operation and the associated platform selection operation may be a triggering action of the user at a specific operation position on the interface of application program in the client. In practical applications, the operation may be triggered by a relevant trigger identification in the client, such as a specific trigger button or input box on the interface in the client, or triggered by a user's voice command The present disclosure does not limit the specific implementation form of the setting operation and the associated platform selection operation.

In an embodiment of the present disclosure, an alternative implementation of the associating the current platform with the platform to be associated through the server may be: associating a first user identification of the current user on the current platform, a first platform identification of the current platform, a second platform identification of the platform to be associated, with a second user identification of the current user on the platform to be associated, through the server. Wherein, the server is a first server corresponding to the current platform and a second server corresponding to the platform to be associated, and at least one of the first server and the second server is a different server, or, the first server and the second server are the same server.

After associating in the above manner, any user on the current platform can view the number of followers of the current user on the current platform and the associated platform through the current platform.

The platform identification is used to identify the platform. Each platform corresponds to a unique platform identification. The platform identification can be text, pictures, symbols, etc. The present disclosure does not limit the specific implementation form of the platform identification. The user identification is used to identify the user. In the same platform, different users correspond to different user identification. The user identification can also be text, pictures, symbols, etc., for example, the user identification may be the registration number generated by the user when registering on the platform. The present disclosure does not limit the specific implementation form of user identification. In the solution of the present disclosure, for different platforms, the same user may share the same user identification, or use different user identification correspondingly, that is, the first user identification and the second user identification may be the same user identification, or different user identification. For example, the first user identification of the current user corresponding to the current platform is user identification A, and the second user identification of the current user corresponding to the associated platform may be the user identification A or user identification B, where the user identification A and the user identification B are different identification.

Where, different platforms may correspond to the same server, and different platforms may also correspond to different servers. If different platforms correspond to different servers and the different platforms include at least three platforms, at least two of the at least three platforms may correspond to one server, and remaining platforms of at least three platforms other than the above at least two platforms may correspond to another server. For example, if there are three platforms, for example, a platform A, a platform B, and a platform C, the platform A and the platform B may correspond to a same server a, the platform C may correspond to a server b, where the server a and the server b are different servers. The at least three platforms may also correspond to one server, for example, the platform A corresponds to a server a, the platform B corresponds to a server b, and the platform C corresponds to a server c, where the server a, the server b, and the server c are different servers.

In practical applications, if different platforms correspond to different servers, the information of platforms to be associated (for example, the first user identification of the current user on the current platform, the first platform identification of the current platform, and the second platform identification of the platform to be associated and the second user identification of the current user on the platform to be associated) are merged into the same platform for association.

As an example, for example, the platforms to be associated are a platform A and a platform B, the current platform is a platform C, where the platform A corresponds to a server a, the platform B corresponds to a server b, and the platform C corresponds to a server c. The platform identification of the platform A and the user identification of the user on the platform A are sent to the server c via the server a, and the platform identification of the platform B and the user identification of user on the platform B are sent to the server c via the server b. The server c associates the user identification of the current user on the platform C, the platform identification of the platform C, the platform identification of the platform B, the user identification of the user on the platform B, the platform identification of the platform A, with the user identification of user on the platform A.

In an embodiment of the present disclosure, in the step S120, in response to the follower number viewing operation, the acquiring the number of users following the current user on the relevant platforms may include:

acquiring the number of users following the current user, based on the first user identification and the first platform identification in the follower number viewing operation.

Based on the specific implementation of associating the current platform with the platform to be associated as described above, the number of users following the current user on the current platform and the associated platform associated with the current platform can be determined based on the first user identification of the current user and the first platform identification of the current platform. That is, the acquired number of users following the current user includes the number of users following the current user on the current platform and the number of users following the current user on the associated platform.

In an embodiment of the present disclosure, the acquiring the number of users following the current user, based on the first user identification and the first platform identification in the follower number viewing operation, may include:

sending to the server a request for acquiring the number of followers, when receiving the follower number viewing operation, the request for acquiring the number of followers comprising the first user identification and the first platform identification;

receiving the number of users following the current user, returned by the server based on the request for acquiring the number of followers, wherein the server acquires the number of users following the current user by the following ways:

acquiring the number of users following the current user on the current platform, based on the first user identification and the first platform identification;

determining the second platform identification associated with the first platform identification, based on the first user identification and the first platform identification;

determining the second user identification of the current user on the associated platform corresponding to the second platform identification, based on the second platform identification and the first user identification; and

acquiring the number of users following the current user on the associated platform corresponding to the second platform identification, based on the second user identification and the second platform identification.

Different platforms may correspond to different servers, or may correspond to the same server. If different platforms correspond to the same server, an alternative implementation of acquiring the number of users following the current user on the relevant platforms (including the current platform and the associated platform) based on the first user identification and the first platform identification, may be: when the client corresponding to the current platform receives the follower number viewing operation, it sends a request for acquiring the number of followers to the server, and sends the first user identification and the first platform identification to the server simultaneously; the server sends the number of users following the current user on the current platform to the client corresponding to the current platform, based on the first user identification and the first platform identification; at the same time, the server determines a second platform identification associated with the first platform identification based on the first user identification and the first platform identification, where the second platform identification can be one or more; the number of users following the current user on the platform (the associated platform) corresponding to the second platform identification can be obtained based on the first platform identification and the second platform identification, and the number of users following the current user on the associated platform is sent to the client corresponding to the current platform.

In practical applications, in the case of different platforms corresponding to different servers, assuming that the current platform corresponds to a server A, and the associated platform corresponds to a server B, then the two servers may acquire the corresponding number of users respectively. Then the acquired number of users may be sent by the two servers to the terminal device corresponding to the current platform respectively, or the acquired number of users may be sent by a single server to the terminal device corresponding to the current platform, where the single server may be either the server A or the server B, or a server different from the server A and the server B, and where the server A and the server B are different servers.

In an embodiment of the present disclosure, after acquiring and displaying the number of users following the current user on the relevant platforms, the method may further include:

receiving a platform selection operation with respect to a target platform of the relevant platforms through a data display interface; and

in response to the platform selection operation, displaying an information display interface corresponding to the target platform.

The platform selection operation refers to an operation through which the user selects a platform of the relevant platforms based on a data display interface, and the specified form of the operation may be configured as needed. For example, it can be a triggering action of the user at a specified operation position on the interface of application program in the client. In practical applications, the operation may be triggered by a relevant trigger identification in the client, such as a specified trigger button or input box on the interface in the client, or triggered by a user's voice command. The present disclosure does not limit the specified implementation form for triggering platform selection operation.

The information display interface is a user interface associated with the target platform. This interface may be used for interaction between a terminal device and a user. The user's related operations may be received through the interface and the information related to the target platform may be displayed. The information displayed on the interface may be configured as needed, and the present disclosure does not limit the specified content of the displayed information.

As an example, the information display interface may be configured to correspond to different target platforms. For example, if the target platform is the current platform, the information display interface may be configured to be the relevant interface corresponding to the current platform, for example, a content list display interface that displays the current user's published contents on the current platform; if the target platform is the associated platform, the information display interface may be configured as a relevant user interface corresponding to the target platform, for example, a content list display interface that displays contents published by the current user on the associated platform.

In the embodiment of the present disclosure, if the application program corresponding to the target platform is not installed on the terminal device corresponding to the current platform, the information display interface includes the application download guide interface corresponding to the target platform.

In actual applications, the application programs corresponding to the user's registered platforms may be installed on different terminal devices. That is, the application programs corresponding to the associated platform and the current platform may be installed on different terminal devices. In the terminal device corresponding to the application program of the current platform, if the application program corresponding to the target platform (the associated platform) is not installed on the terminal device corresponding to the current platform, the information display interface may be the application download guide interface corresponding to the target platform, on which information related to the downloading of application program corresponding to the target platform is displayed, such as a download address. Through the application download guide interface, the user can be provided with guide for downloading the application program corresponding to the target platform.

In practical applications, the application download guide interface may be displayed in suspension on the information display interface, or may be displayed as an independent information display interface.

In an embodiment of the present disclosure, the method may further include:

receiving a download operation for a target platform, through an application download guide interface; and

in response to the download operation, downloading the application program corresponding to the target platform.

The download operation refers to an operation through which the user download the application program corresponding to the target platform based on the application download guide interface, and the specified form of the operation may be configured as needed. For example, it may be a triggering action of the user at a specified operation position on the interface of application program in the client. In practical applications, the operation may be triggered by a relevant trigger identification in the client, such as a specified trigger button or input box on the interface in the client, or triggered by a user's voice command The present disclosure does not limit the specified implementation form for triggering the download operation.

In an embodiment of the present disclosure, the number of users following the current user is displayed by at least one of the following ways:

displaying platform identification of each platform of the relevant platforms and the number of users corresponding to the platform separately; and

displaying a sum of the number of users corresponding to each platform of the relevant platforms.

In actual applications, the display form of the number of users may be configured as needed, and the number of users following the current user on the relevant platform is displayed by at least one of the following forms:

A first form: displaying platform identification of each platform of the relevant platforms and the number of users corresponding to the platform separately.

As an example, relevant platforms include a platform A, a platform B, and a platform C. The platform identification corresponding to the platform A is a, the platform identification corresponding to the platform B is b, and the platform identification corresponding to the platform C is c. If the number of users corresponding to the platform A is acquired as m1, the number of users corresponding to the platform B is acquired as m2, and the number of users corresponding to the platform C is acquired as m3, the platform identification a and the number of users m1, the platform identification b and the number of users m2, and the platform identification c and the number of users m3 may be displayed respectively and correspondingly, for example, the number of users is displayed in a user interface, which is a data display interface. In actual applications, the number of users may be displayed in a designated area of the data display interface. The number of users displayed in the above manner can provide users with a more friendly interaction experience. It should be noted that the designated area may be configured based on actual needs, for example, the middle area in the data display interface.

In addition, in actual applications, in order to distinguish the number of users corresponding to different platforms, the number of users corresponding to different platforms may be distinguished and displayed in different colored fonts, or the number of users corresponding to different platforms may be distinguished and displayed in different fonts. The solutions of the present disclosure do not limit the specified expression form of the number of users.

A second form: displaying a sum of the number of users corresponding to each platform of the relevant platforms.

Another display form of the number of users may be displaying a sum of the number of users corresponding to multiple platforms.

As an example, relevant platforms include a platform A, a platform B. If the number of users corresponding to the platform A is acquired as m1, and the number of uses corresponding to the platform B is acquired as m2, the displayed number of users is a sum of m1 and m2.

In an embodiment of the present application, the current user interface can display relevant information of the current user or other users. If the current user interface displays relevant information of the current user, the current user can view the number of followers herself/himself on each platform through the current user interface. If the current user interface displays relevant information of other users, the current user can view the number of followers of other users on each platform through the current user interface.

As an example, the following takes the current user interface displaying relevant information of the current user, and the current user viewing the number of followers herself/himself on each platform through the current user interface as an example to illustrate the solution of the present disclosure.

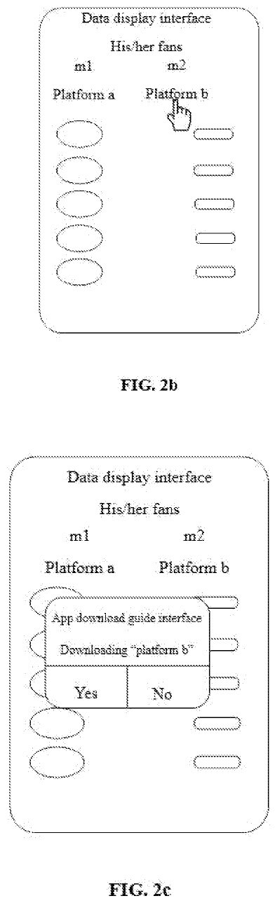

In this example, the current user is a user A, the current platform is a platform a, the associated platform associated with the platform a is a platform b, the platform identification corresponding to the platform a is x, the platform identification corresponding to the platform b is y, and the application program corresponding to the platform a has been installed on the terminal device of user A. Referring to the schematic diagram of the current user interface shown in FIG. 2a, the user interface shown in the figure is the current user interface. In the current user interface, the user A may trigger the follower number view operation by triggering the trigger identification “fans” on the current user interface. Based on this operation, the number of users following user A on the platform a and the platform b may be obtained respectively. The number of users corresponding to the platform a is m1, and the number of users corresponding to the platform b is m2. If the pre-configured display mode of the number of users is to display the number of users corresponding to each platform separately, for example, the number of users being displayed on the data display interface. As shown in the schematic diagram of the data display interface shown in FIG. 2b, the platform identification x of the platform a together with the corresponding number of users m1, and the platform identification y of the platform b together with the corresponding number of users m2 are respectively displayed on the data display interface, and thus the user A can view the number of followers of the user A on the platform a and the platform b respectively through the platform a.

In the data display interface, the trigger identification for the platform selection operation may be configured as needed. Since the platform a and the platform b may be distinguished based on the platform identification x and the platform identification y, in this example, the platform identification x and the platform identification y may be used as the trigger identification for triggering the platform selection operation. In the data display interface, by triggering any one of the platform identification x and the platform identification y, the trigger platform selection operation is received. If the user A triggers the platform identification y, it means that the user A selects the platform b as the target platform. If the application corresponding to the platform b is not installed on the terminal device corresponding to the user A, then refer to the schematic diagram of the application download guide interface shown in FIG. 2c. The application download guide interface is displayed in suspension above the data display interface. The figure shows information about downloading an application program corresponding to the platform b: “Downloading platform b”, “Yes” and “No”. Based on this relevant information, the user may be guided to download the platform b to the terminal device of user A, the specified operation process may be: if the user selects “Yes” based on the guide information displayed in the application download guide interface, the download operation is triggered, and the application program corresponding to the platform b may be downloaded to the terminal device of user A based on this operation; if the user A selects “No” for the download operation, then based on this operation, it may jump to the specified user interface based on the pre-configuration, where the specified user interface may be data display interface or other user interfaces. If the application program corresponding to the platform b has been installed on the terminal device corresponding to user A, refer to the schematic diagram of the information display interface shown in FIG. 2d. As shown in the figure, in the scenario that the application program corresponding to platform b has been installed on the terminal device corresponding to the user A, based on the platform selection operation of the user A, it directly jumps to the information display interface related to platform b, in which user A's related information on platform b may be displayed, such as, a list of published information, user A's personal information on platform b.

In the foregoing embodiment, if the target platform selected by the user A through the data display interface is platform a, that is, the current platform, it remains in the data display interface.

It should be noted that if the user A does not associate the platform a with other platforms on the current platform (the platform a), only the number of users following user A on the current platform may be displayed, when the user A views the number of followers through the solution in this embodiment.

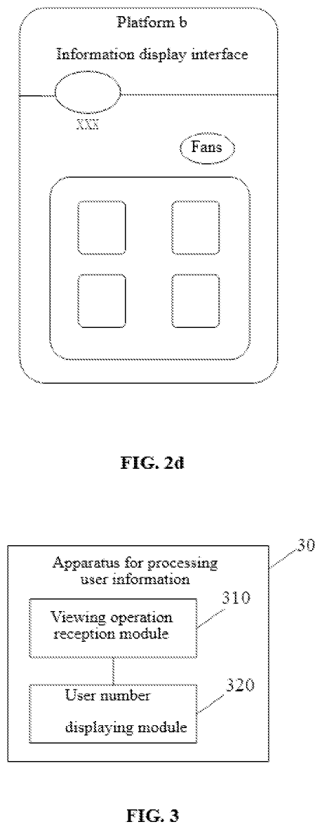

Based on the same principle as the method as shown in FIG. 1, the embodiment of the present disclosure also provides an apparatus 30 for processing user information. As shown in FIG. 3, the apparatus 30 may include: a viewing operation reception module 310 and a user number displaying module 320.

The viewing operation reception module 310 is used for receiving a follower number viewing operation for a current user, through a current user interface of a current platform.

The user number displaying module 320 is used for in response to the follower number viewing operation, acquiring and displaying the number of users following the current user on relevant platforms, wherein the relevant platforms include the current platform and an associated platform associated with the current platform among the current user's registered platforms.

The solution in the embodiment of the present disclosure, may receive a follower number viewing operation for a current user, through a current user interface of a current platform; and based on the follower number viewing operation, may acquire the number of users following the current user on relevant platforms and display it through a data display interface. Since the relevant platforms include the current platform and an associated platform associated with the current platform among the current user's registered platforms, the number of users following the current user on the current platform and other associated platforms may be obtained on the current platform, such that the number of users following the current user on different platforms may be known on one platform at the same time, which improves the user's interaction experience.

In an embodiment of the present disclosure, the apparatus further comprise an associated platform determination module, which determines the associated platform through following ways:

displaying an option of the platform to be associated, when receiving a setting operation for a platform to be associated; and

receiving an associated platform selection operation for the option of the platform to be associated, associating the current platform with the platform to be associated through a server, and determining the platform to be associated as the associated platform of the current platform.

In an embodiment in the present disclosure, when the associating the current platform with the platform to be associated through the server, the associated platform determination module is specifically used for:

associating a first user identification of the current user on the current platform, a first platform identification of the current platform, a second platform identification of the platform to be associated, with a second user identification of the current user on the platform to be associated, through the server; wherein, the server is a first server corresponding to the current platform and a second server corresponding to the platform to be associated, and at least one of the first server and the second server is a different server, or, the first server and the second server are the same server.

In an embodiment in the present disclosure, when acquiring the number of users following the current user on the relevant platforms, in response to the follower number viewing operation, the user number displaying module 320 is specifically used for:

acquiring the number of users following the current user, based on the first user identification and the first platform identification in the follower number viewing operation.

In an embodiment in the present disclosure, when acquiring the number of users following the current user, based on the first user identification and the first platform identification in the follower number viewing operation, the user number displaying module 320 is specifically used for:

sending to the server a request for acquiring the number of followers, when receiving the follower number viewing operation, the request for acquiring the number of followers comprising the first user identification and the first platform identification;

receiving the number of users following the current user, returned by the server based on the request for acquiring the number of followers, wherein the server acquires the number of users following the current user by the following ways:

acquiring the number of users following the current user on the current platform, based on the first user identification and the first platform identification;

determining the second platform identification associated with the first platform identification, based on the first user identification and the first platform identification;

determining the second user identification of the current user on the associated platform corresponding to the second platform identification, based on the second platform identification and the first user identification; and

acquiring the number of users following the current user on the associated platform corresponding to the second platform identification, based on the second user identification and the second platform identification.

In an embodiment in the present disclosure, the apparatus further comprises a platform selection module;

the platform selection module is used for, after acquiring and displaying the number of users following the current user on the relevant platforms, receiving a platform selection operation with respect to a target platform of the relevant platforms; and in response to the platform selection operation, displaying an information display interface corresponding to the target platform.

In an embodiment in the present disclosure, if an application program corresponding to the target platform is not installed on a terminal device corresponding to the current platform, the information display interface includes an application download guide interface corresponding to the target platform.

In an embodiment in the present disclosure, the user number displaying module 320 is specifically used for displaying the number of users following the current user by at least one of the following ways:

displaying platform identification of each platform of the relevant platforms and the number of users corresponding to the platform separately; and

displaying a sum of the number of users corresponding to each platform of the relevant platforms.

The apparatus for processing user information in the embodiments of the present disclosure may perform the method for processing user information provided in the embodiments of the present disclosure, and its implementation principle is similar to the method. The actions executed by modules of the apparatus for processing user information in the embodiments of the present disclosure correspond to the steps in the method for processing user information in embodiments of the present disclosure. For the detailed function description of modules of the apparatus for processing user information, please refer to the foregoing description of the corresponding method for processing user information, and it won't be repeated here.

Based on the same principle as the method for processing user information in the embodiments of the present disclosure, the present disclosure also provide an electronic device, which includes: a processor and a memory; the memory is configured to store operation instructions; the processor is configured to execute the method shown in the any embodiment in the method for processing user information of the present disclosure by invoking the operation instructions.

Based on the same principle as the method for processing user information in the embodiments of the present disclosure, the present disclosure also provide a computer-readable storage medium, wherein the computer-readable storage medium stores at least one instruction, at least one program, a code set or an instruction set, which is loaded and executed by the processor to implement the method shown in the any embodiment in the method for processing user information of the present disclosure.

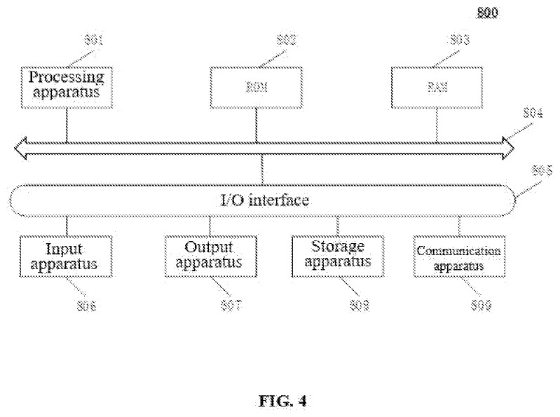

In an example, FIG. 4 illustrates schematic structural diagram of an electronic device 800 (for example, a terminal device or a server implementing the method shown in FIG. 1) suitable for implementing the embodiments of the present disclosure. Wherein, the electronic device in the embodiments of the present disclosure may include, but is not limited to, mobile terminals (such as a mobile phone, a notebook computer, a digital broadcast receiver, a PDA (Personal Digital Assistant), a PAD (Tablet Computer), a PMP (Portable Multimedia Player), and a vehicle terminal (such as vehicle navigation terminal), etc.), and fixed terminals (such as digital TVs, desktop computers, etc.). The electronic device shown in FIG. 4 is only an example, and should not limit the functions and scope of use of the embodiments of the present disclosure.

As shown in FIG. 4, the electronic device 800 may include a processing apparatus (such as a central processing unit, a graphics processor, etc.) 801, which may perform various appropriate actions and processes according to programs stored in a read-only memory (ROM) 802 or programs loaded from the storage apparatus 808 into a random access memory (RAM) 803. In the RAM 803, various programs and data necessary for the operations of the electronic device 800 are also stored. The processing apparatus 801, the ROM 802, and the RAM 803 are connected to each other through a bus 804. An input/output (I/O) interface 805 is also connected to the bus 804.

Generally, the following apparatuses can be connected to the I/O interface 805: including an input apparatus 806 such as a touch screen, touch pad, keyboard, mouse, camera, microphone, accelerometer, gyroscope; an output apparatus 807 including, for example, liquid crystal display (LCD), speakers, vibrator; a storage apparatus 808 including, for example, a magnetic tape, a hard disk; and a communication apparatus 809. The communication apparatus 809 may allow the electronic device 800 to perform wireless or wired communication with other devices to exchange data. Although FIG. 4 shows the electronic device 800 having various apparatuses, it should be understood that it is not required to implement or have all the apparatuses shown. It can be implemented alternatively, or have more or less apparatuses.

In particular, the processes described above with reference to the flowcharts may be implemented as a computer software program according to an embodiment of the present disclosure. For example, an embodiment of the present disclosure comprises a computer program product comprising a computer program loaded on a computer readable medium, and the computer program contains program codes for executing the method shown in the flowchart. In such an embodiment, the computer program may be downloaded and installed from the network via the communication apparatus 809, or installed from the storage apparatus 808, or installed from the ROM 802. When the computer program is executed by the processing apparatus 801, the above functions defined in the method of the embodiments of the present disclosure are executed.

It should be noted that the above computer readable medium of the present disclosure may be a computer readable signal medium or a computer readable storage medium or any combination of the above two. The computer readable storage medium may be, for example, but is not limited to, an electronic, magnetic, optical, electromagnetic, infrared, or semiconductor system, apparatus, or device, or any combination of the above. More specific examples of the computer readable storage media may include, but are not limited to, electrical connections having one or more wires, portable computer disks, hard disks, random access memory (RAM), read only memory (ROM), erasable programmable read only memory (EPROM or flash memory), optical fiber, portable compact disk read only memory (CD-ROM), optical storage device, magnetic storage device, or any suitable combination of the above. In the present disclosure, a computer readable storage medium may be any tangible medium that may contain or store programs, which may be used by or in connection with an instruction execution system, apparatus, or device. In the present disclosure, a computer readable signal medium may comprise a data signal that is propagated in the baseband or propagated as part of a carrier, carrying computer readable program codes. Such propagated data signals may take various forms, which includes, but is not limited to, electromagnetic signals, optical signals, or any suitable combination of the above. The computer readable signal medium may also be any computer readable medium except for a computer readable storage medium, and the computer readable signal medium may transmit, propagate, or transport a program for use by or in connection with an instruction execution system, apparatus, or device. Program codes contained on the computer readable medium may be transmitted by any suitable medium, which includes but is not limited to: wire, optic cable, RF (radio frequency), and the like, or any suitable combination of the above.

The above computer readable medium may be contained in the above electronic device; or may be separately present and is not incorporated in the electronic device.

The computer readable medium carries one or more programs, when the one or more programs are executed by the electronic device, causing the electronic device to execute the method shown in the above embodiment.

Computer program codes for executing the operations of the present disclosure may be written in one or more programming languages, or combinations thereof, wherein the programming languages comprises an object-oriented programming language such as Java, Smalltalk, C++, and also comprises conventional procedural programming language—such as “C” language or similar programming languages. The program codes may be executed entirely on the user's computer, partly executed on the user's computer, executed as an independent software package, partly executed on the user's computer and partly executed on the remote computer, or entirely executed on the remote computer or on the server. In the case of involving the remote computer, the remote computer may be connected to the user's computer through any kind of network, including a local area network (LAN) or a wide area network (WAN), or may be connected to an external computer (e.g., using an Internet service provider to connect via Internet).

The flowchart and block diagrams in the drawings illustrate the architecture, function, and operation of possible implementations of systems, methods, and computer program products according to various embodiments of the present disclosure. In this regard, each block of the flowchart or block diagram may represent one module, a program segment, or a portion of the codes, and the module, the program segment, or the portion of codes comprises one or more executable instructions for implementing the specified logic functions. It should also be noted that in some alternative implementations, the functions noted in the blocks may also occur in an order different from the order noted in the drawings. For example, two successively represented blocks may in fact be executed substantially in parallel, and they may sometimes be executed in the opposite order, depending upon the involved function. It is also noted that each block of the block diagrams and/or flowcharts, and combinations of blocks in the block diagrams and/or flowcharts, may be implemented in a dedicated hardware-based system that executes the specified functions or operations, or it may be implemented by a combination of dedicated hardware and computer instructions.

The units involved in the embodiments described in the present disclosure may be implemented in a software manner, and may also be implemented in a hardware manner. Wherein, the name of the unit does not constitute a limitation on the unit itself under certain circumstances. For example, the first obtaining unit can also be described as “a unit for obtaining at least two Internet Protocol addresses”.

The above description is only a preferred embodiment of the present disclosure and a description of the principles of the applied technology. It should be understood by those skilled in the art that the disclosure scope of the present disclosure is not limited to the specified technical solutions of the above technical features, and should also cover other technical solutions formed by the random combination of the above technical features or equivalent features thereof without departing from the above disclosed concept, such as a technique solution in which the above features are replaced with technical features having similar functions disclosed (but is not limited) in the present disclosure.

1. A method for processing user information, comprising:
receiving a follower number viewing operation for a current user, through a current user interface of a current platform; and
in response to the follower number viewing operation, acquiring and displaying a number of users following the current user on relevant platforms, wherein the relevant platforms include the current platform and an associated platform associated with the current platform among platforms registered by the current user.

2. The method according to claim 1, wherein, the associated platform is determined through following ways:
displaying an option of the platform to be associated, when receiving a setting operation for a platform to be associated; and
receiving an associated platform selection operation for the option of the platform to be associated, associating the current platform with the platform to be associated through a server, and determining the platform to be associated as the associated platform of the current platform.

3. The method according to claim 2, wherein, the associating the current platform with the platform to be associated through the server comprises:
associating a first user identification of the current user on the current platform, a first platform identification of the current platform, a second platform identification of the platform to be associated, with a second user identification of the current user on the platform to be associated, through the server;
wherein, the server is a first server corresponding to the current platform and a second server corresponding to the platform to be associated, and at least one of the first server and the second server is a different server, or, the first server and the second server are the same server.

4. The method according to claim 3, wherein, in response to the follower number viewing operation, acquiring the number of users following the current user on the relevant platforms, comprises:
acquiring the number of users following the current user, based on the first user identification and the first platform identification in the follower number viewing operation.

5. The method according to claim 4, wherein, the acquiring the number of users following the current user, based on the first user identification and the first platform identification in the follower number viewing operation, comprises:
sending to the server a request for acquiring the number of followers, when receiving the follower number viewing operation, the request for acquiring the number of followers comprising the first user identification and the first platform identification; and
receiving the number of users following the current user, returned by the server based on the request for acquiring the number of followers, wherein the server acquires the number of users following the current user by the following ways:
acquiring the number of users following the current user on the current platform, based on the first user identification and the first platform identification;
determining the second platform identification associated with the first platform identification, based on the first user identification and the first platform identification;
determining the second user identification of the current user on the associated platform corresponding to the second platform identification, based on the second platform identification and the first user identification; and
acquiring the number of users following the current user on the associated platform corresponding to the second platform identification, based on the second user identification and the second platform identification.

6. The method according to claim 1, wherein, after acquiring and displaying the number of users following the current user on the relevant platforms, the method further comprises:
receiving a platform selection operation with respect to a target platform among the relevant platforms; and
in response to the platform selection operation, displaying an information display interface corresponding to the target platform.

7. The method according to claim 6, wherein, if an application program corresponding to the target platform is not installed on a terminal device corresponding to the current platform, the information display interface includes an application download guide interface corresponding to the target platform.

8. The method according to claim 1, wherein, displaying the number of users following the current user by at least one of the following ways, comprises:
displaying platform identification of each platform among the relevant platforms and the number of users corresponding to each platform, respectively; and
displaying a sum of the number of users corresponding to each platform among the relevant platforms.

9. An apparatus for processing user information, comprising:
a viewing operation reception module, configured to receive a follower number viewing operation for a current user, through a current user interface of a current platform; and
a user number displaying module, configured to acquire and display a number of users following the current user on relevant platforms, in response to the follower number viewing operation, wherein the relevant platforms include the current platform and an associated platform associated with the current platform among platforms registered by the current user.

10. An electronic device, comprising:
a memory configured to store computer operation instructions; and
a processor configured to invoke the computer operation instructions to execute the method of claim 1.

11. A computer-readable storage medium, wherein the computer-readable storage medium stores at least one instruction, at least one program, a code set or an instruction set, which is loaded and executed by a processor to implement the followings steps:
receiving a follower number viewing operation for a current user, through a current user interface of a current platform; and
in response to the follower number viewing operation, acquiring and displaying a number of users following the current user on relevant platforms, wherein the relevant platforms include the current platform and an associated platform associated with the current platform among platforms registered by the current user.

12. The computer-readable storage medium according to claim 11, wherein, the associated platform is determined through following ways:
displaying an option of the platform to be associated, when receiving a setting operation for a platform to be associated; and
receiving an associated platform selection operation for the option of the platform to be associated, associating the current platform with the platform to be associated through a server, and determining the platform to be associated as the associated platform of the current platform.

13. The computer-readable storage medium according to claim 12, wherein, the associating the current platform with the platform to be associated through the server comprises:
associating a first user identification of the current user on the current platform, a first platform identification of the current platform, a second platform identification of the platform to be associated, with a second user identification of the current user on the platform to be associated, through the server;
wherein, the server is a first server corresponding to the current platform and a second server corresponding to the platform to be associated, and at least one of the first server and the second server is a different server, or, the first server and the second server are the same server.

14. The computer-readable storage medium according to claim 13, wherein, in response to the follower number viewing operation, acquiring the number of users following the current user on the relevant platforms, comprises:
acquiring the number of users following the current user, based on the first user identification and the first platform identification in the follower number viewing operation.

15. The computer-readable storage medium according to claim 14, wherein, the acquiring the number of users following the current user, based on the first user identification and the first platform identification in the follower number viewing operation, comprises:
sending to the server a request for acquiring the number of followers, when receiving the follower number viewing operation, the request for acquiring the number of followers comprising the first user identification and the first platform identification; and
receiving the number of users following the current user, returned by the server based on the request for acquiring the number of followers, wherein the server acquires the number of users following the current user by the following ways:
acquiring the number of users following the current user on the current platform, based on the first user identification and the first platform identification;
determining the second platform identification associated with the first platform identification, based on the first user identification and the first platform identification;
determining the second user identification of the current user on the associated platform corresponding to the second platform identification, based on the second platform identification and the first user identification; and
acquiring the number of users following the current user on the associated platform corresponding to the second platform identification, based on the second user identification and the second platform identification.

16. The computer-readable storage medium according to claim 11, wherein, after acquiring and displaying the number of users following the current user on the relevant platforms, the method further comprises:
receiving a platform selection operation with respect to a target platform among the relevant platforms; and
in response to the platform selection operation, displaying an information display interface corresponding to the target platform.

17. The computer-readable storage medium according to claim 16, wherein, if an application program corresponding to the target platform is not installed on a terminal device corresponding to the current platform, the information display interface includes an application download guide interface corresponding to the target platform.

18. The computer-readable storage medium according to claim 11, wherein, displaying the number of users following the current user by at least one of the following ways, comprises:
displaying platform identification of each platform among the relevant platforms and the number of users corresponding to each platform, respectively; and
displaying a sum of the number of users corresponding to each platform among the relevant platforms.
